(19) United States
(12) Patent Application Publication
(10) Pub. No.: US 2010/0161435 A1
(43) Pub. Date: Jun. 24, 2010

(54) COMMODITY DISPLAY QUANTITY MANAGING SYSTEM AND COMMODITY DISPLAY QUANTITY MANAGING METHOD

(75) Inventors: Kenji Shimizu, Tokyo (JP); Kenya Hiramatsu, Tokyo (JP); Akio Hiruma, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/640,641

(22) Filed: Dec. 17, 2009

(30) Foreign Application Priority Data
Dec. 22, 2008 (JP) 2008-326347

(51) Int. Cl. G06Q 30/00; G06F 19/00; G06Q 10/00; G08B 13/14

(52) U.S. Cl. 705/22; 235/385; 705/28; 340/572.1; 235/380; 235/375

(57) ABSTRACT

RFID tags are attached to commodities sold in a selling floor of a store. The RFID tags have stored therein identification codes for enabling identification of the RFID tags. An RFID reader configured to read the identification codes stored in the RFID tags is attached to a commodity display shelf on which the commodities are displayed. When a display quantity of stock of the commodities displayed on the commodity display shelf changes and the display quantity of stock decreases to be equal to or smaller than a predetermined alert value, a server causes a radio access point to output a reporting signal for causing a PDA terminal to perform reporting operation. A store clerk can learn, by checking a message displayed by the PDA terminal, that the display quantity of stock of the commodities decreases and can take timing for display work for commodities.

### CROSS-REFERENCE TO RELATED APPLICATION

This application claims the benefit of priority from Japanese Patent Application No. 2008-326347 filed on Dec. 22, 2008, the entire content of which is incorporated herein by reference.

### TECHNICAL FIELD

The present invention relates to a commodity display quantity managing system and a commodity display quantity managing method for managing the quantity of commodities displayed in a display section such as a commodity display shelf set in a store.

### BACKGROUND

When a retail store sells commodities, it is important to display the commodities to arouse commodity purchase desire of customers in the store. In selling the commodities in the store, a so-called minimum display quantity (also called minimum display amount and safe stock) is known. The minimum display quantity means the number of commodities under which sales of commodities displayed in the store stops or suddenly falls. It is empirically known that, as an example, such a phenomenon tends to occur in volume-sales apparel stores. Therefore, a store clerk needs to appropriately perform display work for displaying commodities in a display place in order to maintain the number of commodities at least equal to or larger than the minimum display quantity.

As an example of a technique for supporting the display work for the commodities performed by the store clerk, there is a display supporting system disclosed in JP-A-2006-202147. The display supporting system is installed in, for example, a sales store for motorbikes. Three or more radio communication units provided in the sales store perform radio communication with radio IC tags (RFID tags) attached to motorbikes. The display supporting system calculates distances between the radio IC tags and the radio communication units using time required for receiving radio signals, specifies the positions of the radio IC tags on the basis of the principle of triangulation, and grasps where the motorbikes are displayed.

In the retail store, a customer repeatedly picks up a commodity from a display place for commodities and returns the commodity to determine a commodity that the customer purchases. As a result, the number of commodities displayed in the display place frequently fluctuates. In such circumstances, the store clerk has to perform the display work for commodities while performing various kinds of work. In the technique disclosed in JP-A-2006-202147, an instruction for supplying a stock of commodities is issued every time the radio IC tags attached to the motorbikes are not detected by the radio communication units. Therefore, the store clerk has to suspend various kinds of work that the store clerk performs.

The technique disclosed in JP-A-2006-202147 is applied to a large store in which several tens motorbikes can be displayed. In a store in which display places for commodities are finely set, display work cannot be carefully performed for the respective display places.

### SUMMARY

It is an object of the present invention to realize efficiency of display work for commodities performed by a store clerk.

According to an aspect of the present invention, there is provided a commodity display quantity managing system including: an RFID reader configured to read, from RFID tags attached to commodities displayed in display sections, identification codes for identifying the RFID tags; a signal output unit configured to output a reporting signal for causing a reporting terminal to perform reporting operation; and a system control unit configured to calculate, on the basis of the identification codes read by the RFID reader, the display quantity of stock of the commodities displayed in the display sections and perform, when the display quantity of stock is equal to or smaller than a predetermined alert value stored by a storing unit, signal output processing for causing the signal output unit to output the reporting signal.

According to another aspect of the present invention, there is provided a commodity display quantity managing method for a commodity display quantity managing system including: an RFID reader configured to read, from RFID tags attached to commodities displayed in display sections, identification codes for identifying the RFID tags; and a signal output unit configured to output a reporting signal for causing a reporting terminal to perform reporting operation, the method including a system control unit calculating, on the basis of the identification codes read by the RFID reader, the display quantity of stock of the commodities displayed in the display sections and performing, when the display quantity of stock is equal to or smaller than a predetermined alert value stored by a storing unit, signal output processing for causing the signal output unit to output the reporting signal.

According to the present invention, the display quantity of stock of the commodity displayed in the display section is grasped and, when the display quantity of stock is equal to or smaller than the predetermined alert value, the reporting terminal performs the reporting operation. When a minimum display quantity is set as the alert value, the reporting terminal performs the reporting operation for the first time at a stage when the number of commodities displayed in the display section decreases by such a degree as to affect sales of a store. Therefore, a store clerk can concentrate on work other than display work for commodities until the reporting terminal performs the reporting work. It is possible to increase efficiency of the display work for commodities performed by the store clerk.

### DESCRIPTION OF THE DRAWINGS

FIG. 1 is a schematic diagram of an entire commodity display quantity managing system according to a first embodiment of the present invention;

FIG. 2 is a schematic front view of a commodity display shelf;

FIG. 3 is a block diagram of the electric configuration of a server;

FIGS. 4A to 4C and FIGS. 5A and 5B are diagrams for explaining a database stored by a NAS;

FIG. 6 is a flowchart for explaining a flow of processing performed by the commodity display quantity managing system;

FIG. 7 is a flowchart for explaining a flow of alert processing;

FIGS. 8A and 8B are diagrams for explaining a database stored by a NAS according to a second embodiment of the present invention;

FIG. 9 is a schematic diagram of the structure of a store-front stock table stored by the NAS;

FIG. 10 is a flowchart for explaining a flow of store-front stock update processing;

FIG. 11 is a flowchart for explaining a flow of alert processing;

FIG. 12 is a diagram for explaining a database stored by a NAS according to a third embodiment of the present invention; and

FIG. 13 is a flowchart for explaining a flow of processing performed by a commodity display quantity managing system.

### DETAILED DESCRIPTION

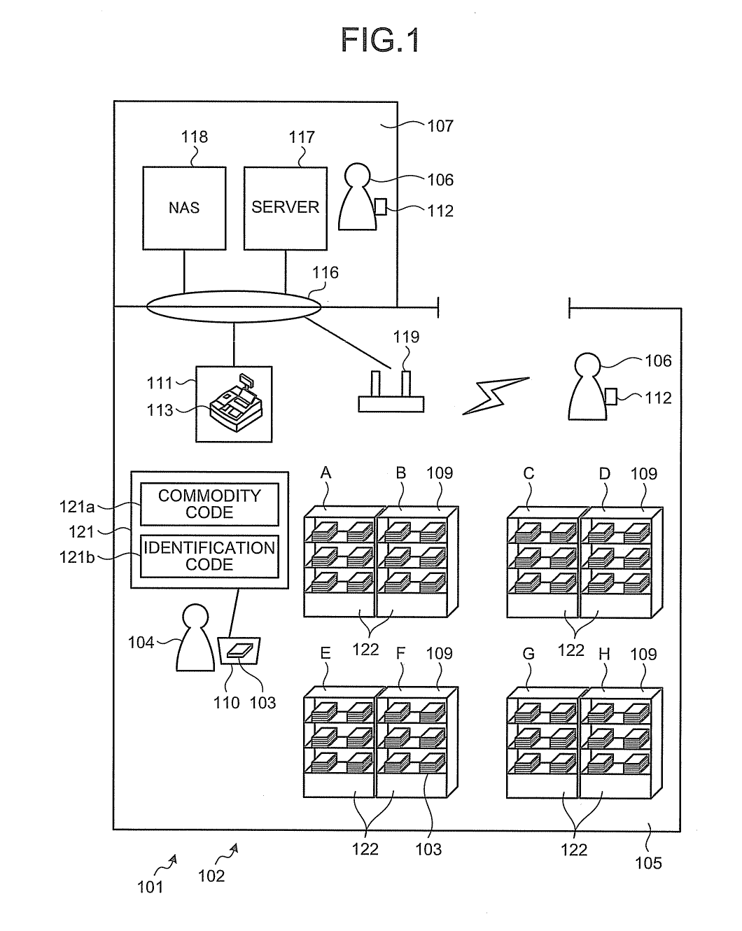

A first embodiment of the present invention is explained below with reference to FIGS. 1 to 7.

FIG. 1 is a schematic diagram of an entire commodity display quantity managing system 101. The commodity display quantity managing system 101 is installed in a supermarket 102 as a store. The supermarket 102 is sectioned into a selling floor space 105 where commodities 103 are displayed and a customer 104 purchases the commodities 103 and a backyard 107 where only a store clerk 106 is allowed to enter.

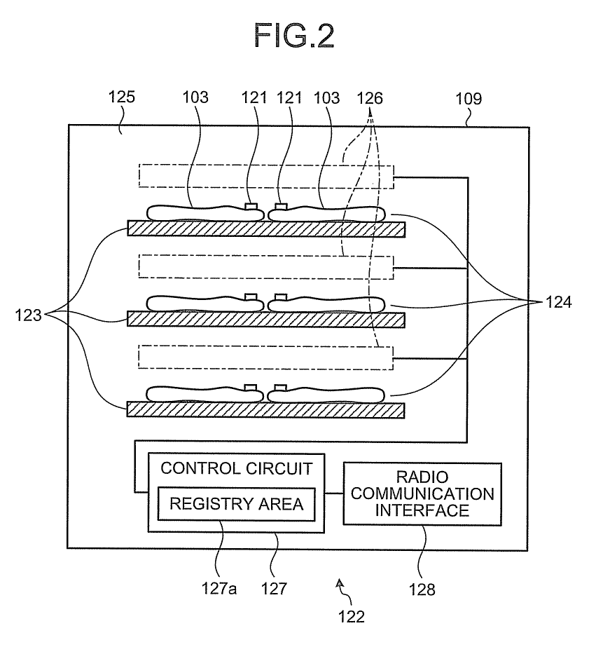

In the selling floor space 105, eight commodity display shelves 109 as display sections are set. The commodity display shelves 109 include commodity display shelves A to H as shown in FIG. 1. Clothes are displayed on the commodity display shelves A to D. Foods are displayed on the commodity display shelves E to G. The commodity display shelf H is a place specially prepared for selling only specific commodities 103. As shown in FIG. 2, each of the commodity display shelves 109 includes an RFID reader 122. Each of the commodity display shelves 109 includes a shelf code for identifying the commodity display shelf 109. As an example, a shelf code of the commodity display shelf A is “T00000A”, a shelf code of the commodity display shelf B is “T00000B”, and a shelf code of the commodity display shelf H is “T00000H”. The customer 104 walks around the selling floor space 105 carrying a shopping basket 110 prepared by the supermarket 102 in advance, puts the commodity 103 that the customer 104 is about to purchase in the shopping basket 110, carries the commodity 103 to a register area 111, and pays for the commodity 103. The customer 104 may directly carry the commodity 103 by hand without using the shopping basket 110 and pay for the commodity 103. The store clerk 106 guides the customer 104 and performs commodity display work in the selling floor space 105. The store clerk 106 performs stock check work in the backyard 107. The store clerk 106 stands by in a service counter (not shown) in the selling floor space 105 and guides the customer 104. The store clerk 106 operates a POS terminal 113 set in the register area 111 of the selling floor space 105 and performs settlement of the commodity 103 purchased by the customer 104. The POS terminal 113 has a function of a settlement unit configured to settle an account of the commodity 103 sold by the supermarket 102.

A server 117 as a system control unit set in the backyard 107, a NAS (Network Attached Storage) 118 as a storing unit, the POS terminal 113, and a radio access point 119 are connected to one another by a LAN 116 disposed in the supermarket 102.

As an example, the radio access point 119 is set on the ceiling (not shown) of the selling floor space 105. The radio access point 119 performs radio communication with a PDA terminal 112 functioning as a reporting terminal carried by the store clerk 106 during a job. The server 117 and the radio access point 119 function as signal output units configured to transmit radio signals.

RFID tags 121 are attached to all commodities 103 displayed on the commodity display shelves 109. Each of the RFID tags 121 has stored therein a commodity code 121a for specifying a type of the commodity 103. The RFID tag 121 has also stored therein an identification code 121b. The identification code 121b is a unique and independent code allocated to each of the RFID tags 121 in order to identify the RFID tag 121.

FIG. 2 is a schematic front view of the commodity display shelf 109. In the commodity display shelf 109, three shelf plates 123 for absorbing radio waves are arranged, whereby three commodity storage spaces 124 are provided. As explained above, each of the commodity display shelves 109 includes the RFID reader 122. The RFID reader 122 includes antennas 126 and a control circuit 127.

The control circuit 127 includes a registry area 127a in which data can be stored. The control circuit 127 has stored therein a shelf code of the commodity display shelf 109 to which the RFID reader 122 is attached. The control circuit 127 is connected to a radio communication interface 128. The radio communication interface 128 transmits a radio signal to the radio access point 119 (see FIG. 1).

The antennas 126 are attached to a back plate 125 of the commodity display shelf 109 in the commodity storage spaces 124. The antennas 126 perform near-distance radio communication with the RFID tags 121. Since the antennas 126 are provided to cover the full distance in the width direction of the commodity storage spaces 124, no matter where the RFID tags 121 are placed in the commodity storage spaces 124, the antennas 126 can perform the near-distance radio communication with the RFID tags 121.

The control circuit 127 is provided in a lower part of the commodity display shelf 109. The control circuit 127 reads, via the antennas 126, the commodity codes 121a and the identification codes 121b stored by the RFID tags 121 attached to the commodities 103. The control circuit 127 causes the radio communication interface 128 to transmit, as a radio signal, the read commodity codes 121a and identification codes 121b and the shelf code of the commodity display shelf 109 in association with each other.

The control circuit 127 cannot simultaneously communicate with all the plural RFID tags 121 in the commodity storage spaces 124. Therefore, the RFID reader 122 sequentially performs data communication with the RFID tags 121 and sequentially acquires the commodity codes 121a and the identification codes 121b from the RFID tags 121. In other words, in some case, the RFID reader 122 performs again data communication with the RFID tag 121 with which the RFID reader 122 already performs data communication.

Therefore, when the control circuit 127 receives the commodity code 121a and the identification code 121b from each of the RFID tags 121, the control circuit 127 determines, with reference to the registry area 127a, whether the identification code 121b received this time is an already-received identification code 121b stored in the registry area 127a. If the control circuit 127 determines that the identification code 121b received this time is different from the already-received identification code 121b, the control circuit 127 stores the commodity code 121a and the identification code 121b received this time in the registry area 127a. The control circuit 127 repeats a series of processing including the data reception, the determination, and the data storage for a predetermined time set in advance. The predetermined time is time that is, when a storage capacity for the commodities 103 that can be displayed in the commodity storage spaces 124 is taken into account, sufficient for reading the RFID tags 121 of all the commodities 103 stored in the commodity storage spaces 124.

In this way, the control circuit 127 stores, in the registry area 127a, the commodity codes 121a and the identification codes 121b of the RFID tags 121 attached to all the commodities 103 displayed in the commodity storage spaces 124.

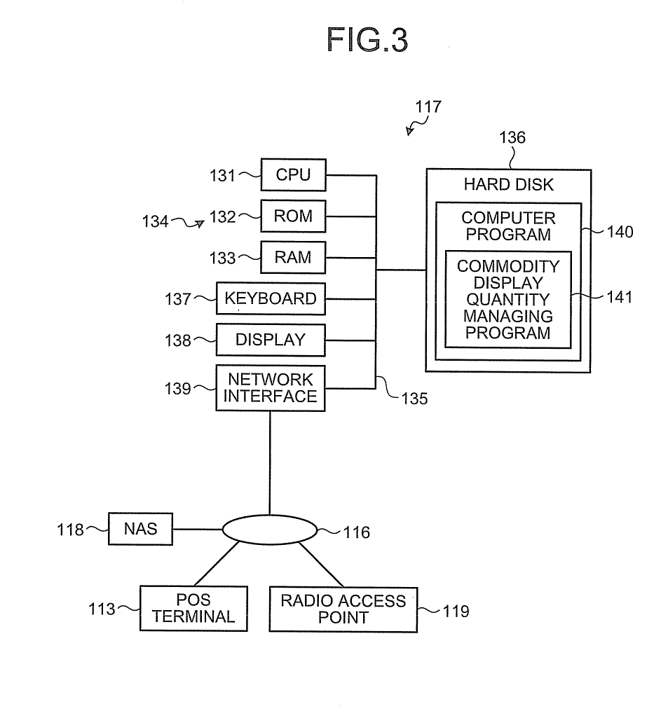

FIG. 3 is a block diagram of the electric configuration of the server 117. The server 117 includes an information processing unit 134 including a CPU 131, a ROM 132, and a RAM 133. The information processing unit 134 is connected to a hard disk 136, a keyboard 137, a display 138, and a network interface 139 via a bus line 135. The server 117 performs, through the network interface 139, data communication with the POS terminal 113 and the radio access point 119 connected to the LAN 116.

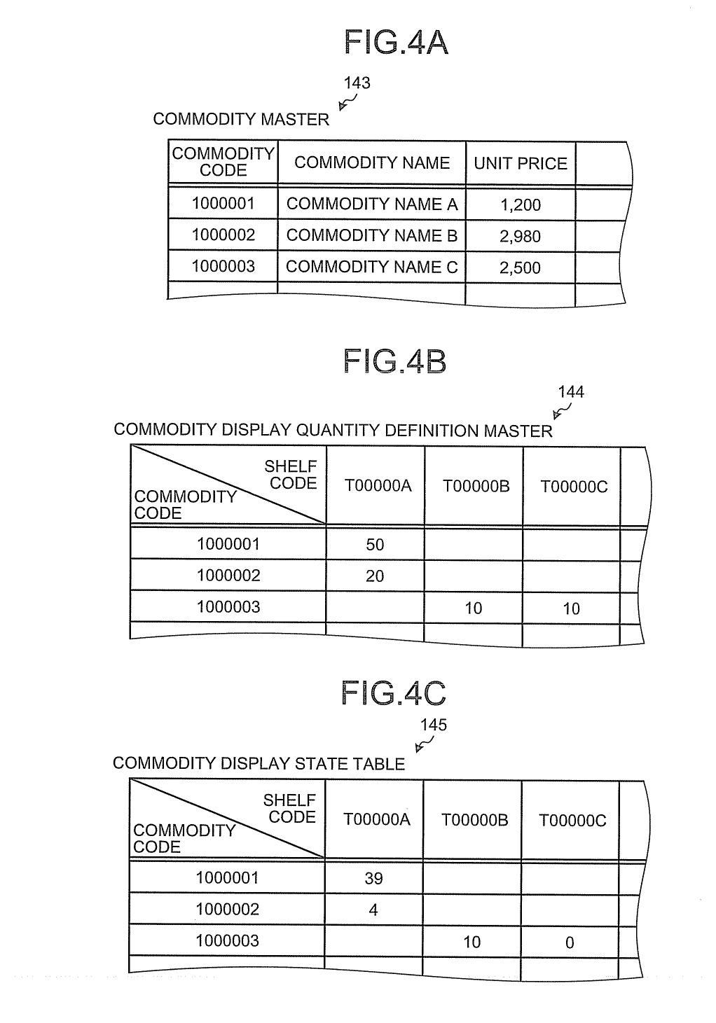

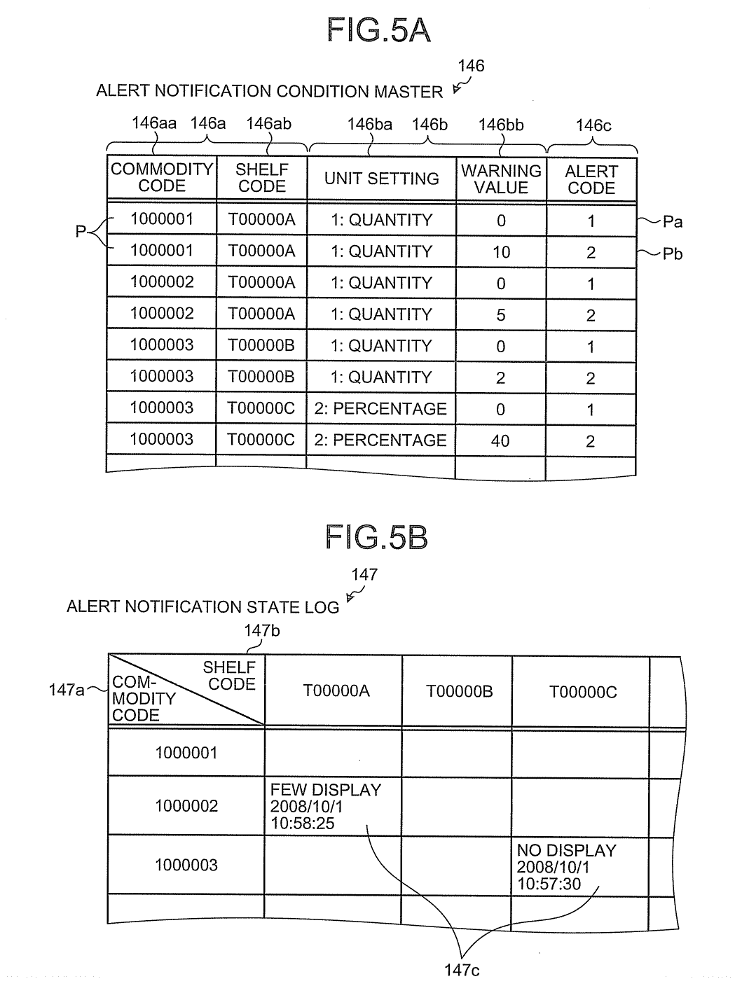

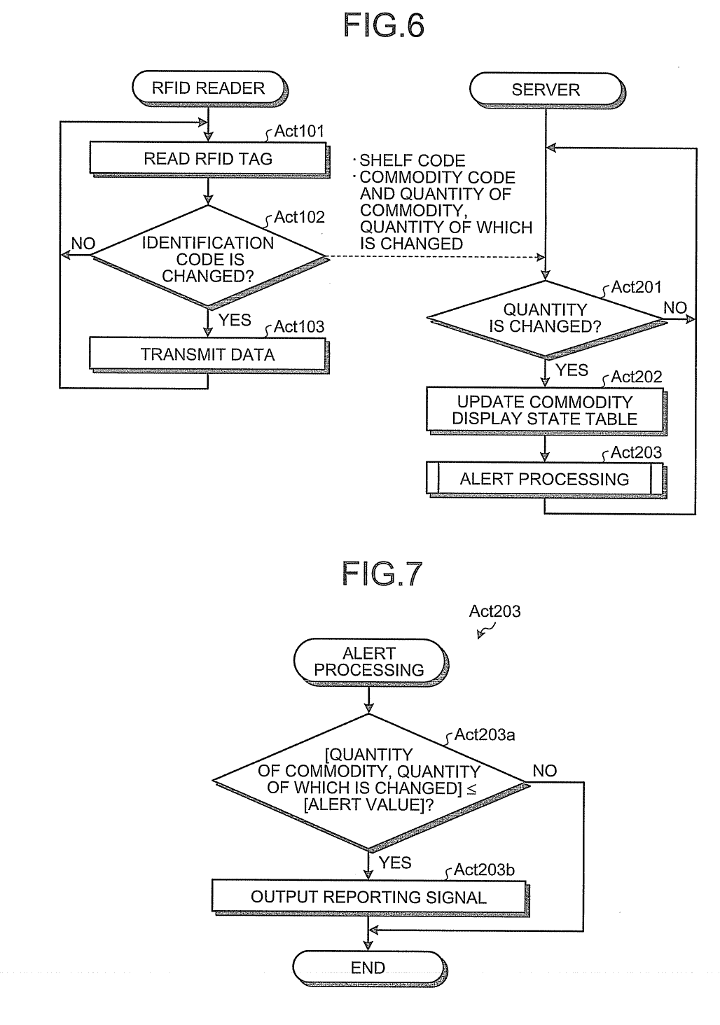

The hard disk 136 has stored therein a computer program 140 for causing the CPU 131 to execute various kinds of information processing. The computer program 140 includes a commodity display quantity managing program 141 for causing the CPU 131 to execute processing shown in FIGS. 6 and 7. The computer program 140 also includes an OS and a driver program. The computer program 140 also includes a computer program for causing the server 117 to access the NAS 118 and read data from and write data in various data files (see FIGS. 4A to 4C and FIGS. 5A and 5B) stored by the NAS 118. The CPU 131 copies the entire computer program 140 or a part of the computer program 140 to the RAM 133 during the start of the server 117 and executes the computer program 140.

FIGS. 4A to 4C and FIGS. 5A and 5B are diagrams for explaining a database stored by the NAS 118. The NAS 118 has stored therein a commodity master 143 (FIG. 4A), a commodity display quantity definition master 144 (FIG. 4B), and a commodity display state table 145 (FIG. 4C). The NAS 118 has also stored therein an alert notification condition master 146 (FIG. 5A) and an alert notification state log 147 (FIG. 5B).

The commodity master 143 (FIG. 4A) has stored therein a commodity name, a unit price, and the like corresponding to a commodity code in association with the commodity code. The commodity master 143 is a file used by the POS terminal 113 to perform settlement processing and is also called PLU (Price Look Up) file. The POS terminal 113 includes a code scanner (not shown). A control unit (not shown) of the POS terminal 113 reads, with the code scanner, a barcode (not shown) attached to the commodity 103 and receives the input of the commodity code 121a. The POS terminal 113 may include an RFID reader and read the RFID tag 121 attached to the commodity 103 to thereby receive the input of the commodity code 121a. When the control unit of the POS terminal 113 receives the input of the commodity code 121a, the control unit reads, from the commodity master 143, a commodity name and a unit price of the commodity 103 corresponding to the received commodity code 121a and uses the commodity name and the unit price for settlement processing. In order to increase the speed of the settlement processing of the POS terminal 113, the POS terminal 113 may download the commodity master 143 from the NAS 118 via the LAN 116, store the commodity master 143 in a not-shown memory of the POS terminal 113, and use the commodity master 143.

The commodity display quantity definition master 144 (FIG. 4B) has stored therein a maximum number of displayed commodities of the commodities 103 having respective commodity codes that can be displayed on the commodity display shelves 109 having respective shelf codes. For example, FIG. 4B indicates that fifty commodities having a commodity code “1000001” can be displayed on the commodity display shelf A with the shelf code “T00000A”. A user can change the maximum number of displayed commodities stored in the commodity display quantity definition master 144 by operating, after causing the server 117 to execute the computer program 140, the keyboard 137 and the display 138 to input the maximum number of displayed commodities.

The commodity display state table 145 (FIG. 4C) stores the display quantity of stock of the commodities 103 having the respective commodity codes currently displayed on the commodity display shelves 109 having the respective shelf codes. For example, FIG. 4C indicates that thirty-nine commodities having the commodity code “1000001” are currently displayed on the commodity display shelf A with the shelf code “T00000A”. The commodity display state table 145 can be updated in Act 202 shown in FIG. 6.

The commodity display quantity managing system 101 according to this embodiment reports to the PDA terminal 112 or the like when the number of commodities 103 (the display quantity of stock) displayed on the commodity display shelf 109 decreases. The alert notification condition master 146 and the alert notification state log 147 shown in FIGS. 5A and 5B are used for this report processing.

The alert notification condition master 146 (FIG. 5A) has stored therein alert conditions P for causing the PDA terminal 112 or the like to perform reporting operation. The alert notification condition master 146 includes a key field 146a in which a commodity code 146aa and a shelf code 146ab are stored. The alert notification condition master 146 includes an alert value field 146b and an alert code field 146c.

The alert value field 146b has stored therein, for each of the commodities 103 having the respective commodity codes, an alert value (a warning value) that defines the display quantity of stock of the commodity 103 with which the PDA terminal 112 performs alert notification.

The alert code field 146c has stored therein an alert code that defines types of reporting operations (alerts) performed by the PDA terminal 112 when the display quantity of stock of the commodity 103 reaches respective alert values.

The alert value field 146b (FIG. 5B) includes a warning value field 146bb in which numerical values are stored and a unit setting field 146ba in which a unit of the numerical values stored in the warning value field 146bb is set. For example, when the unit setting field 146ba is “1: quantity”, the CPU 131 of the server 117 recognizes the unit of the numerical value stored in the warning value field 146bb as “piece” and defines, as an alert value, the number of commodities equivalent to the numerical value stored in the warning value field 146bb. When the unit setting field 146ba is “2: percentage”, the CPU 131 of the server 117 recognizes the unit of the numerical value stored in the warning value field 146bb as “%” and defines, as an alert value, the number of commodities equivalent to a numerical value obtained by multiplying a percentage indicated by the numerical value with a maximum number of displayed commodities in the commodity display shelf 109 for the commodities 103 grasped according to the key field 146a (the commodity code 146aa and the shelf code 146ab) with reference to the commodity display quantity definition master 144.

The CPU 131 of the server 117 determines, according to the alert code stored in the alert code field 146c, a type of a reporting signal output in Act 203b of alert processing (FIG. 7) as explained below.

| | | message displayed by the |
|---|---|---|
| Alert code | alert type | PDA terminal 112 |
| 1 | no store-front | commodities are not |
| | display | displayed in the store |
| | | front |
| 2 | small quantity of | the number of displayed |
| | store-front | commodities in the store |
| | display | front is small |

An alert code with a higher emergency degree is set to a smaller numerical value.

The user can change the alert conditions P of the alert notification condition master 146 by operating, after causing the server 117 to execute the computer program 140, the keyboard 137 and the display 138 to input a maximum number of displayed commodities.

What is important is that, in the alert notification condition master 146, even if alert conditions are the same in the commodity code 146aa and the shelf code 146ab of the key field 146a, the alert conditions can be set as different conditions if the alert conditions are different in the warning value field 146bb. The user needs to set, for a smaller alert value with a higher emergency degree, a smaller alert code corresponding to a message with a high emergency degree.

The alert notification state log 147 (FIG. 5B) is a log file in which it is recorded for each of the shelf codes when the insufficiency of the display quantity of stock of the commodity 103 with each of the commodity codes is reported. In Act 203b of the alert processing shown in FIG. 7, the CPU 131 of the server 117 writes logs 147c in association with both a commodity code 147a and a shelf code 147b.

FIG. 6 is a flowchart for explaining a flow of processing performed by the RFID reader 122 and the server 117 in the commodity display quantity managing system 101.

The control circuit 127 of the RFID reader 122 periodically emits a radio wave, performs near-distance radio communication with the RFID tags 121 in the commodity display shelf 109, and sequentially acquires the commodity codes 121a and the identification codes 121b from the RFID tags 121 attached to all the commodities 103 displayed on the commodity display shelf 109 (Act 101). The control circuit 127 of the RFID reader 122 determines whether a change occurs in the identification codes 121b of the RFID tags 121 stored in the registry area 127a (Act 102) and monitors the movement of the commodities 103 in the commodity display shelf 109. If the control circuit 127 of the RFID reader 122 determines that a change occurs in the identification codes 121b stored in the registry area 127a (Y in Act 102), the control circuit 127 transmits, with reference to the registry area 127a, the commodity code 121a of the commodities 103, the quantity of which changes, the number of identification codes 121b (the number of commodities 103) having the commodity code 121a, and the shelf code 146ab to the server 117 via the radio communication interface 128.

The CPU 131 of the server 117 starts the commodity display quantity managing program 141 during the start of the apparatus. The CPU 131 of the server 117 reads the alert conditions P from the alert notification condition master 146 and stores the alert conditions P in the RAM 133. The CPU 131 of the server 117 stands by until the shelf code 146ab, the commodity code 121a, and the number of commodities 103 transmitted by the RFID reader 122 are received and determines whether the display quantity of stock changes (Act 201). If the display quantity of stock changes (Y in Act 201), the CPU 131 of the server 117 updates the commodity display state table 145 on the basis of the received shelf code 146ab, commodity code 121a, and number of commodities 103 (Act 202). The CPU 131 of the server 117 performs the alert processing shown in FIG. 7 (Act 203).

FIG. 7 is a flowchart for explaining a flow of the alert processing. The CPU 131 of the server 117 refers to the alert conditions P stored by the RAM 133 and determines, with reference to the alert conditions P of the shelf code 146ab and the commodity code 121a transmitted from the RFID reader 122, whether the number of the commodities (the display quantity of stock) 103 after the quantity change is equal to or smaller than the alert value of the alert condition P corresponding thereto (Act 203a). If the CPU 131 of the server 117 determines that the number of commodities 103 is equal to or smaller than the alert value (Y in Act 203a), the CPU 131 performs signal output processing for outputting a reporting signal to the radio communication interface 128 (Act 203b). The radio communication interface 128 transmits the reporting signal to the radio access point 119.

The reporting signal is a signal for causing the PDA terminal 112 to perform reporting operation corresponding to the alert code stored in the alert code field 146c of the alert condition P. The reporting signal includes the shelf code 146ab of the commodity display shelf 109 in which the quantity change occurs and the commodity code 121a of the commodities 103. The reporting signal also includes the alert code, the alert type, and the message displayed by the PDA terminal 112 explained above with reference to FIGS. 5A and 5B.

When the CPU 131 of the server 117 ends Act 203b and ends the alert processing in Act 203 shown in FIG. 6, the CPU 131 returns to Act 201 shown in FIG. 6 and repeats Acts 201 to 203.

What is important in the signal output processing in Act 203b is that, when there are plural alert conditions P that satisfy the determination in the processing in Act 203a, the CPU 131 of the server 117 adopts the alert condition P having a smaller alert code. For example, when no commodity 103 having the commodity code “1000001” is displayed on the commodity display shelf 109 with the shelf code “T00000A”, in Act 203a, both of an alert condition Pa and an alert condition Pb (see FIG. 5A) correspond to the alert conditions P that satisfy the determination in the processing in Act 203a. The CPU 131 adopts the alert condition Pa with a smaller alert code of these two alert conditions in Act 203b. The radio access point 119 outputs a reporting signal corresponding to the alert code “1”.

In the supermarket 102 in which the commodity display quantity managing system 101 according to this embodiment is installed, display work for the commodities 103 performed by the store clerk 106 is made efficient as explained below.

First, the store clerk 106 operates the keyboard 137 and the display 138 of the server 117 to edit the commodity display quantity definition master 144 (FIG. 4A) and the alert notification condition master 146 (FIG. 5A) stored in the NAS 118.

During business hour, the control circuit 127 of the RFID reader 122 reads, via the antenna 126, the commodity code 121a and the identification code 121b from the RFID tag 121 of the commodity 103 displayed on the commodity display shelf 109 to which the RFID reader 122 is attached. The control circuit 127 of the RFID reader 122 stores the read data in the registry area 127a. The commodity codes 121a and the identification codes 121b stored in the registry area 127a change according to the movement of the commodities 103. Therefore, the control circuit 127 of the RFID reader 122 grasps the commodity code 121a corresponding to the identification code 121b added to the registry area 127a or the commodity code 121a corresponding to the identification code 121b deleted from the registry area 127a. The control circuit 127 transmits the commodity code 121a and the number of identification codes 121b corresponding to the commodity code 121a stored in the registry area 127a to the server 117. The server 117 that receives the data updates the commodity display state table 145 stored in the NAS 118. Thereafter, when the number of commodities 103 displayed on the commodity display shelf 109 is equal to or smaller than the alert value, the server 117 performs the alert processing (FIG. 7) and outputs a reporting signal from the radio access point 119.

In the commodity display quantity managing system 101 according to this embodiment, the alert code has an important meaning. Specifically, in the alert notification condition master 146, two sets decided by a combination of the commodity code 146aa and the shelf code 146ab are prepared as the alert conditions P. In one of the sets, “0” is stored in the warning value field 146bb and “1” is stored in the alert code field 146c. In the other set, a numerical value equal to or larger than 0 is stored in the warning value field 146bb and “2” is stored in the alert code field 146c. As explained above, in Act 203b of the alert processing (FIG. 7), the alert condition P with a smaller value of values stored in the alert code field 146c is preferentially adopted.

Therefore, as an example, when it is determined that there is no commodity 103 having the commodity code “1000001” in the commodity display shelf A with the shelf code “T000001”, the CPU 131 of the server 117 adopts the alert condition Pa (see FIG. 5A) with a smaller alert code and causes the PDA terminal 112 to perform reporting operation corresponding to the alert code “1”. As another example, when it is determined that there are eighteen commodities 103 having the commodity code “1000001” in the commodity display shelf A, the CPU 131 of the server 117 adopts the alert condition Pb (see FIG. 5B) and causes the PDA terminal 112 to perform reporting operation corresponding to the alert code “2”.

The commodity display quantity managing system 101 sets a minimum display quantity in the alert value field 146b as an alert value for causing the PDA terminal 112 to perform the reporting operation corresponding to the alert code “2”. Therefore, the PDA terminal 112 performs the reporting operation corresponding to the alert code “2” for the first time at a point when the quantity of the commodities 103 displayed on the commodity display shelf 109 decreases to a stage that affects sales of the commodities 103.

Therefore, the store clerk 106 only has to perform display work for the commodities 103 for the first time at a point when the display quantity of stock reaches the minimum display quantity. Until that point, the store clerk 106 can concentrate on work other than the display work for the commodities 103. In other words, with the commodity display quantity managing system 101 according to this embodiment, it is possible to increase efficiency of the display work for the commodities 103 performed by the store clerk 106.

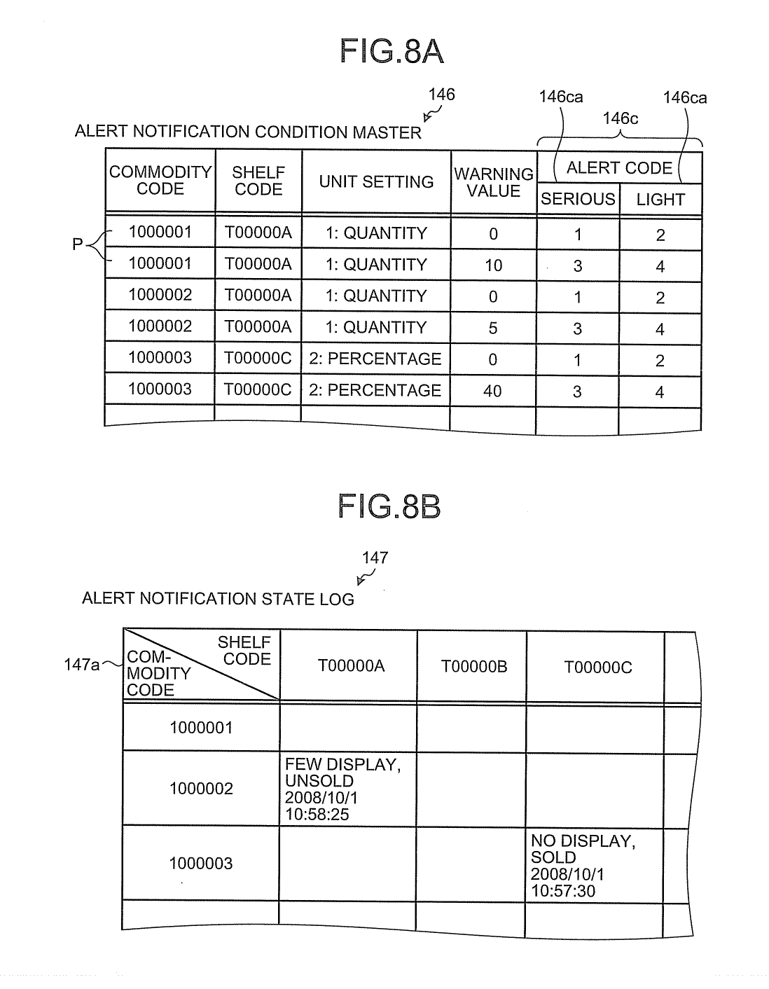

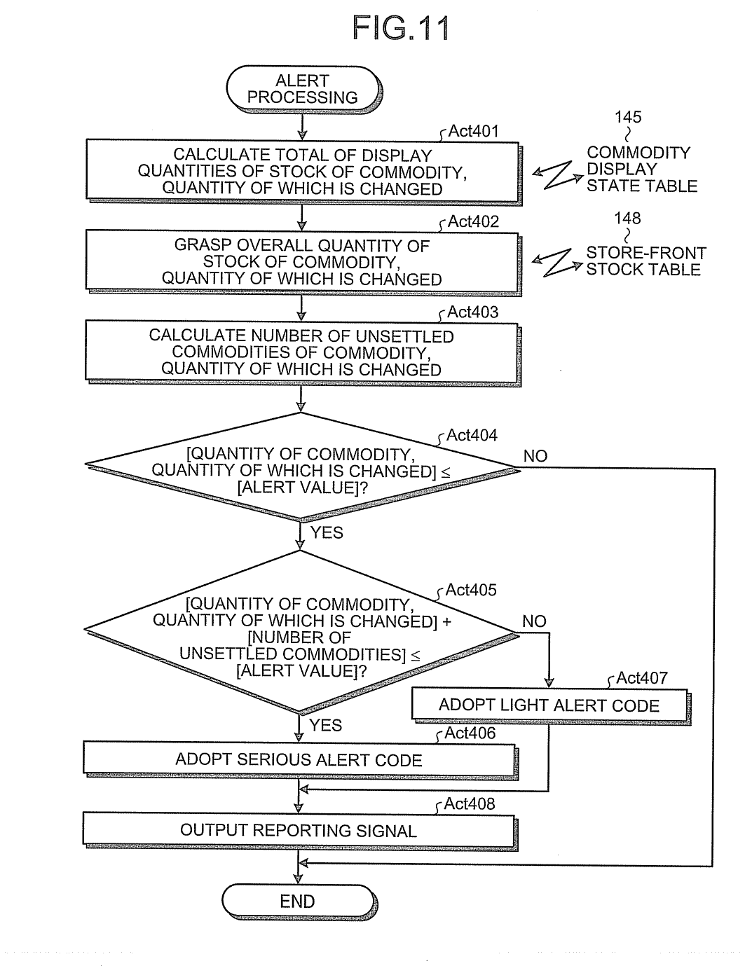

A second embodiment of the present invention is explained below with reference to FIGS. 8A and 8B to FIG. 11. Components same as those in the first embodiment are denoted by the same reference numerals and signs and explanation of the components is omitted. The commodity display quantity managing system 101 according to this embodiment causes the PDA terminal 112 to perform two kinds of reporting operation using an overall quantity of stock in the supermarket 102 in alert processing (FIG. 11) and taking into account the quantity of unsettled commodities in the supermarket 102.

FIGS. 8A and 8B are diagrams for explaining a database stored in the NAS 118 according to the second embodiment. The alert notification condition master 146 according to this embodiment includes, as the alert code field 146c, a serious alert code field 146ca in which an alert code for outputting a serious reporting signal is stored and a light alert code field 146cb in which an alert code for outputting a light reporting signal is stored. The CPU 131 of the server 117 determines, according to the alert codes stored in the alert code field 146c (the serious alert code field 146ca and the light alert code field 146cb), a type of a reporting signal output in Act 408 of the alert processing (FIG. 11) as explained below.

| | | message displayed by the |
|---|---|---|
| Alert code | alert type | PDA terminal 112 |
| 1 | no store-front | commodities are not |
| | display (sold) | displayed in the store |
| | | front (sold) |
| 2 | no store-front | commodities are not |
| | display (unsold) | displayed in the store |
| | | front (unsold) |
| 3 | small quantity of | the number of displayed |
| | store-front | commodities in the store |
| | display (sold) | front is small (sold) |
| 4 | small quantity of | the number of displayed |
| | store-front | commodities in the store |
| | display (unsold) | front is small (unsold) |

As shown in FIG. 8B, the alert notification state log 147 according to this embodiment is recorded such that the alert types can be identified.

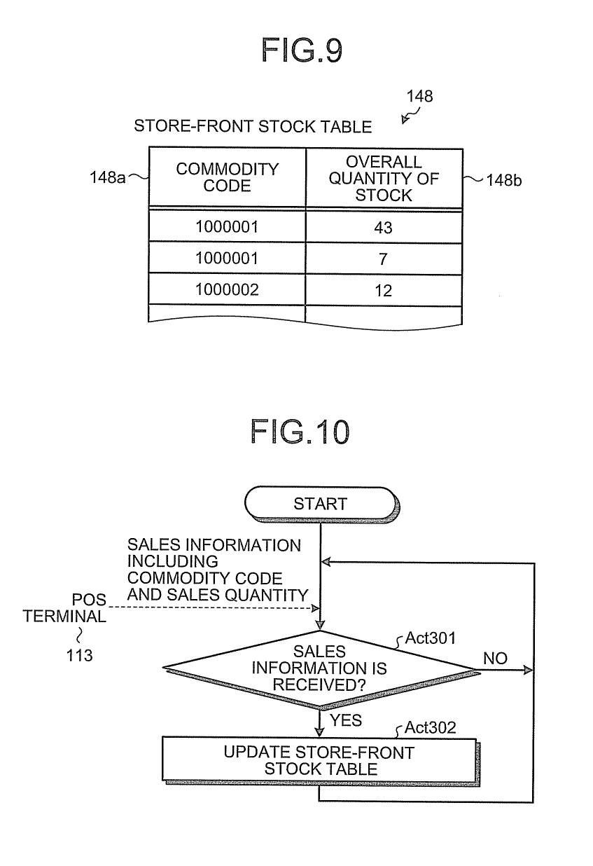

FIG. 9 is a schematic diagram of the structure of a store-front stock table 148 stored in the NAS 118. The store-front stock table 148 has stored therein, for each of commodity codes 148a, an overall quantity of stock 148b in the entire store of the commodities 103 displayed in the supermarket 102. The store-front stock table 148 is updated by store-front stock update processing shown in FIG. 10.

FIG. 10 is a flowchart for explaining a flow of the store-front stock update processing. The CPU 131 of the server 117 stands by for reception of sales information transmitted from the POS terminal 113 (Act 301). The sales information includes information concerning amounts settled by the POS terminals 113 and various kinds of information such as commodity codes and a quantity of the commodities 103 treated in the settlement. If the CPU 131 of the server 117 receives the sales information (Y in Act 301), the CPU 131 reflects the received sales information on a sales record database (not shown) stored in the NAS 118. The CPU 113 of the server 117 accesses, concerning a commodity, the store-front stock of which is reduced by the settlement, the store-front stock table 148 and updates the overall quantity of stock 148b (Act 302). In other words, the server 117 according to this embodiment functions as an overall-quantity-of-stock updating unit.

FIG. 11 is a flowchart for explaining a flow of the alert processing. The CPU 131 of the server 117 according to this embodiment accesses, as the alert processing in Act 203 shown in FIG. 6, the commodity display state table 145 (see FIG. 4C). The CPU 131 of the server 117 calculates, concerning the commodity 103, the quantity of which is changed in Act 201 shown in FIG. 6, a total number of the display quantities of stock of the commodity 103 in all the commodity display shelves 109 in the supermarket 102 (Act 401). The CPU 131 of the server 117 accesses the store-front stock table 148 (see FIG. 9) and grasps an overall quantity of stock in the supermarket 102 of the commodity 103, the quantity of which is changed (Act 402).

The CPU 131 of the server 117 subtracts the total number of the display quantities of stock calculated in Act 401 from the overall quantity of stock acquired in Act 402 to calculate the number of unsettled commodities (Act 403). The number of unsettled commodities indicates a quantity of the commodity 103 that is taken out from the commodity display shelf 109 by the customer 104 but is not settled by the POS terminal 113.

The CPU 131 of the server 117 determines whether the number of commodities 103 after the quantity change is equal to or smaller than the alert value (Act 404). If the CPU 131 determines that the number of commodities 103 after the quantity change is equal to or smaller than the alert value (Y in Act 404), the CPU 131 shifts to Act 405. If the CPU 131 determines that the number of commodities 103 after the quantity change is not equal to or smaller than the alert value (N in Act 404), the CPU 131 ends the alert processing and shifts to Act 201 shown in FIG. 6.

In Act 405, the CPU 131 of the server 117 refers to the alert condition P corresponding to the shelf code of the commodity display shelf 109 in which the quantity change occurs and the commodity code of the commodity 103 among the alert conditions P stored in the RAM 133. The CPU 131 of the server 117 determines whether a total of the number of commodities 103 after the quantity change and the number of unsettled commodities calculated in Act 403 is equal to or smaller than an alert value set in the corresponding alert condition P (Act 405).

If the total of the number of commodities 103 after the quantity change and the number of unsettled commodities is equal to or smaller than the alert value (Y in Act 405), the CPU 131 adopts the alert code stored in the serious alert code field 146ca defined in the alert condition P (Act 406). Subsequently, the CPU 131 outputs a reporting signal based on the serious alert code to the radio communication interface 128 (Act 408). The radio communication interface 128 transmits the reporting signal to the radio access point 119. The CPU 131 ends the alert processing and returns to Act 201 shown in FIG. 6.

On the other hand, if the total of the number of commodities 103 after the quantity change and the number of unsettled commodities is larger than the alert value (N in Act 405), the CPU 131 adopts the alert code stored in the light alert code field 146cb defined in the alert condition P (Act 407). The CPU 131 outputs a reporting signal based on the light alert code to the radio communication interface 128 (Act 408). The radio communication interface 128 transmits the reporting signal to the radio access point 119. The CPU 131 ends the alert processing and returns to Act 201 shown in FIG. 6.

The commodity display quantity managing system 101 according to this embodiment is characterized by comparing a value obtained by adding the number of unsettled commodities to the quantity of the commodity 103 with the alert value and outputting a different reporting signal according to whether the value is larger or not larger than the alert value. In other words, even when the display quantity of stock changes, if the commodity 103 is not settled, it is likely that the customer 104 returns the commodity 103 to the commodity display shelf 109. Therefore, if the commodity 103 is unsettled, the commodity display quantity managing system 101 displays, on the PDA terminal 112, an indication that, although the display quantity of stock reaches the alert value, the unsettled (unsold) commodity 103 is included in the display quantity of stock. This makes it possible to inform the store clerk 106 that emergency of commodity supply is low. In other words, the store clerk 106 can perform supply work for commodities at more appropriate timing.

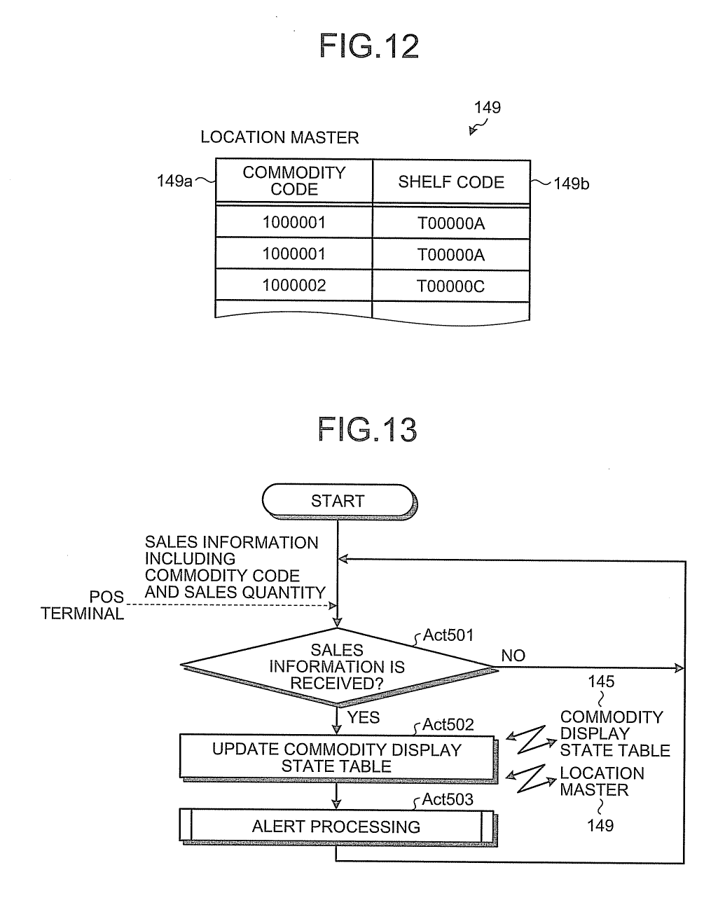

A third embodiment of the present invention is explained below with reference to FIGS. 12 and 13. The commodity display quantity managing system 101 according to this embodiment updates the store-front stock table 148 (see FIG. 9) according to settlement processing performed by the POS terminal 113 and regards the overall quantity of stock 148b stored in the store-front stock table 148 as the display quantity of stock in the commodity display shelf 109. Components same as those in the first and second embodiments are denoted by the same reference numerals and signs and explanation of the components is omitted.

FIG. 12 is a diagram for explaining a database stored by the NAS 118 according to the third embodiment. In this embodiment, the commodities 103 with the same commodity code 149a are displayed in the same commodity display shelf 109 specified by the commodity code 149a. The NAS 118 has stored therein a location master 149. The location master 149 has stored therein a shelf code 149b of the commodity display shelf 109 specified by the commodity code 149a in association with the commodity code 149a.

FIG. 13 is a flowchart for explaining a flow of processing performed by the commodity display quantity managing system 101. In this embodiment, the CPU 131 of the server 117 starts the commodity display quantity managing program 141 and stands by for reception of sales information transmitted from the POS terminal 113 (Act 501). As explained in the second embodiment, the sales information includes information concerning amounts settled by the POS terminals 113 and various kinds of information such as commodity codes and a quantity of the commodities 103 treated in the settlement.

If the CPU 131 of the server 117 receives the sales information (Y in Act 501), the CPU 131 reflects the sales information on a sales record database (not shown) stored by the NAS 118. The CPU 131 of the server 117 updates, on the basis of the received sales information, the display quantity of stock of the commodity 103, in which a quantity change occurs, in the commodity display state table 145 (Act 502). In other words, the server 117 functions as a display-quantity-of-stock updating unit. In Act 502, the CPU 131 acquires the shelf code 149b corresponding to a commodity code included in the sales information with reference to the location master 149. The CPU 131 of the server 117 shifts to alert processing (Act 503).

As explained in Act 502 shown in FIG. 13, the commodity display quantity managing system 101 according to this embodiment updates the commodity display state table 145 in association with the settlement in the POS terminal 113. The commodities 103 having the same commodity code are displayed on only the same commodity display shelf 109. In other words, the display quantity of stock of the commodity 103 and the overall quantity of stock of the commodity 103 in the supermarket 102 are the same value. Therefore, unlike the second embodiment, it is unnecessary to calculate and compare the display quantity of stock of the commodity 103 in the commodity display shelf 109 and the overall quantity of stock in the supermarket 102. Therefore, in the alert processing in Act 503 shown in FIG. 13, the CPU 131 of the server 117 performs the alert processing in the first embodiment shown in FIG. 7.

In the commodity display quantity managing system 101 according to this embodiment, it is unnecessary to attach the RFID reader 122 to the commodity display shelf 109. Therefore, there is an effect that the commodity display quantity managing system 101 is easily installed in the supermarket 102.

In the above explanation, the PDA terminal 112 is used as the reporting terminal. As another embodiment, it is also possible to use the POS terminal 113 as the reporting terminal, perform alert display on a display (not shown) of the POS terminal 113 as the reporting operation, and cause the store clerk 106 (a casher) to recognize a decrease in the commodities 103 in the commodity display shelf 109.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. A commodity display quantity managing system comprising:
an RFID reader configured to read, from RFID tags attached to commodities displayed in display sections, identification codes for identifying the RFID tags;
a signal output unit configured to output a reporting signal for causing a reporting terminal to perform reporting operation; and
a system control unit configured to calculate, on the basis of the identification codes read by the RFID reader, a display quantity of stock of the commodities displayed in the display sections and perform, when the display quantity of stock is equal to or smaller than a predetermined alert value stored by a storing unit, signal output processing for causing the signal output unit to output the reporting signal.

2. The system according to claim 1, wherein
the storing unit has stored therein a plurality of the predetermined alert values in association with a plurality of the display quantities of stock,
the system control unit outputs, in the signal output processing, when the display quantity of stock is equal to or lower than at least one of the alert values, the reporting signal according to the alert value, and
the signal output unit causes the reporting terminal to perform the reporting operation according to the reporting signal.

3. The system according to claim 2, wherein the system control unit outputs, in the signal output processing, when the display quantity of stock is equal to or smaller than the plurality of the alert values, the reporting signal corresponding to a smaller one of the alert values.

4. The system according to claim 1, wherein the storing unit has stored therein, as the predetermined alert value, a minimum display quantity as a quantity of the commodities displayed in the display sections at which sales of the commodities starts to be affected.

5. The system according to claim 1, further comprising:
a settling unit configured to perform settlement concerning the commodities; and
an overall-quantity-of-stock updating unit configured to update, on the basis of a number of commodities settled by the settling unit, an overall quantity of stock stored by the storing unit indicating a quantity of stock of commodities in the store, wherein
the signal output unit outputs a plurality of the reporting signals different from one another and causes the reporting terminal to perform the reporting operation corresponding to each of the reporting signals, and
the system control unit subtracts the display quantity of stock in all the display sections from the overall quantity of stock stored by the storing unit to calculate a number of unsettled commodities in the store and causes, in the signal output processing, the signal output unit to output the different reporting signals when a total of the display quantity of stock in a same one of the display sections and the number of unsettled commodities is equal to or smaller than the alert value and when the total is larger than the alert value.

6. The system according to claim 1, further comprising:
a settling unit configured to perform settlement concerning the commodities and transmit, when the settlement is performed, commodity codes of the commodities and a number of the commodities; and
a display-quantity-of-stock updating unit configured to update, on the basis of the commodity codes of the commodities and the number of commodities received from the settling unit, the display quantity of stock in the store stored by the storing unit, wherein
the system control unit performs the signal output processing when the display quantity of stock updated by the display-quantity-of-stock updating unit is equal to or smaller than the predetermined alert value.

7. The system according to claim 6, wherein
each of the display sections displays the commodities having a same one of the commodity codes, and
the storing unit has stored therein display section identification codes for identifying the display sections and the commodity codes of the commodities displayed in the display sections in association with each other.

8. A commodity display quantity managing method for a commodity display quantity managing system including:
an RFID reader configured to read, from RFID tags attached to commodities displayed in display sections, identification codes for identifying the RFID tags; and
a signal output unit configured to output a reporting signal for causing a reporting terminal to perform reporting operation,
the method comprising a system control unit calculating, on the basis of the identification codes read by the RFID reader, a display quantity of stock of the commodities displayed in the display sections and performing, when the display quantity of stock is equal to or smaller than a predetermined alert value stored by a storing unit, signal output processing for causing the signal output unit to output the reporting signal.

9. The method according to claim 8, wherein
the commodity display quantity managing system further includes:
a settling unit configured to perform settlement concerning the commodities; and
an overall-quantity-of-stock updating unit configured to update, on the basis of a number of commodities settled by the settling unit, an overall quantity of stock stored by the storing unit indicating a quantity of stock of commodities in the store, and
the method further comprises:
the signal output unit outputting a plurality of the reporting signals different from one another and causing the reporting terminal to perform the reporting operation corresponding to each of the reporting signals, and
the system control unit subtracting the display quantity of stock in all the display sections from the overall quantity of stock stored by the storing unit to calculate a number of unsettled commodities in the store and causing, in the signal output processing, the signal output unit to output the different reporting signals when a total of the display quantity of stock in a same one of the display sections and the number of unsettled commodities is equal to or smaller than the alert value and when the total is larger than the alert value.

10. The method according to claim 8, wherein
the commodity display quantity managing system further includes:
a settling unit configured to perform settlement concerning the commodities and transmitting, when the settlement is performed, commodity codes of the commodities and a number of the commodities; and
a display-quantity-of-stock updating unit configured to update, on the basis of the commodity codes of the commodities and the number of commodities received from the settling unit, the display quantity of stock in the store stored by the storing unit, and
the method further comprises the system control unit performing the signal output processing when the display quantity of stock updated by the display-quantity-of-stock updating unit is equal to or smaller than the predetermined alert value.
